(19) United States
(12) Patent Application Publication
(10) Pub. No.: US 2008/0127556 A1
(43) Pub. Date: Jun. 5, 2008

(54) Sliding door gate

(76) Inventors: James P. Trujillo, Plumas Lake, CA (US); Erika Trujillo, Plumas Lake, CA (US); Daysha Trujillo, Plumas Lake, CA (US)

Correspondence Address: James P. Trujillo, 2239 Sheridan Ranch Circle, Plumas Lake, CA, 95961, US

(21) Appl. No.: 11/510,877

(22) Filed: Aug. 25, 2006

(51) Int. Cl. E05F 5/06

(52) U.S. Cl. 49/28

(57) ABSTRACT

A sliding door safety gate attaches to the sliding door, using the sliding door clamps 50, while enabling the user to enter and exit freely while using it. This safety gate detours small children, pets, or like from exiting the sliding door. The back 10 and front 20 panels are used to enable the user to adjust the width of the safety gate. The safety gates stationary vertical gate support 30 is used to secure the gate to the sliding door, while the height adjustment pin allows the user to adjust the height of the gate according to the track height of the users sliding door. The hinges 40 allow the user to swing open or close the panels easily and the connecting slidable clamps 60 allow the user to extend or retract the safety gate according to width of the sliding door. The safety gate locking mechanism 70 is located on the top of the back panel 10 which allows the user to secure the safety gate in place when in use. The shield 90 protects small children, pets, or like from putting their hand, foot, or head through the mesh.

### CROSS-REFERENCE TO RELATED APPLICATIONS

NONE

### SEQUENCE LISTING OR PROGRAM

NONE

### BACKGROUND OF THE INVENTION

1. Field of Invention

This invention generally relates to safety gates for sliding doors, specifically to obstruct sliding doors, patio doors, and similar opening's, when open, to restrict the movement of small children, pets, and the like.

2. Prior Art

A variety of gates are presently on the market that are designed to prevent children from passing from one area to another. Several of these gates can be adjusted for use in openings having various widths. Several of these gates also include moveable bumpers that can be extended from and retracted into the gate to respectively secure and release the gate from the openings.

A disadvantage of known gates that utilize moveable bumpers is that the mechanisms used to actuate the bumpers are complex and expensive. These gates conventionally incorporate mechanisms that include numerous interconnecting parts that require precise fits and positioning to interact with each other to extend and retract the bumpers. Gates are also known that utilize actuating mechanisms that include a complex arrangement of links, cranks, pull rods and springs that are interconnected to a pull handle.

Another disadvantage associated with known gates is an inability of the moveable plungers to independently compensate for different spacings between each bumper and the side member of an opening. Different spacings can result from various factors such as surface irregularities of the vertical members of an opening, an opening having nonparallel vertical members and the like. Conventionally, known gates use rigid connections between the bumpers and actuating mechanism that can result in a bumper making minimal or no contact with a vertical member of the opening or a bumper exerting a very high force against the vertical member of an opening. However, the actuating mechanism incorporated in this gate is a complex assemblage of parts that is expensive to manufacture.

Another disadvantage associated with known gates is the inability to grasp the sliding door without slipping.

Accordingly, it is an object of the present invention to provide an improved safety gate which enables the user to overcome these and other disadvantages associated with sliding doors.

3. Objects and Advantages

Accordingly, several objects and advantages of the invention are:
(a) to provide a safety gate which prevents toddlers from pushing out screen doors
(b) to provide a safety gate which clamps on to the sliding door allowing user to enter and exit easily
(c) to provide a safety gate which assists in confining a child, pet, or like from exiting the home through the patio door
(d) to provide a safety gate which allows the user to leave their sliding door open and their screen door closed allowing circulation throughout the home
(e) to provide a safety gate which allowing the sliding door to stay open while having small infants, pets, or like in the area of the sliding door
(f) to provide a safety gate which is an additional detourant for families with swimming pools

Further objects and advantages are to provide a safety gate which can be used easily and prevents indoor pets from ruining the screen door. Still further objects and advantages will become apparent from a consideration of the ensuing description and drawings.

### SUMMARY

This invention is a new concept for safety gates because this gate is made specifically for sliding patio doors. Many children and pets like to play and accidentally run through patio screen doors. The safety gate can also have a safety alarm alarming parents if the child is tampering or has opened the gate. This safety gate is made of two panels. The vertical outer leg sits on the vertical pin which is placed in the sliding door track. The vertical outer leg is braced to the sliding door with a type of clamp. One clamp on the top and bottom of the left side of the vertical outer leg. Connected to the vertical outer leg also are hinges that are also placed on the top and bottom to allow the two panels to pivot.

As a further aspect of the invention, the safety gate comprises a pair of generally flat gate sections, a locking device joining the gate sections together, and a pair of horizontally extending bumpers mounted on the outer frame member of the second gate section. A handle latching device may be provided to keep both panels locked into position.

Accordingly several objects and advantages of the invention are to provide a safety gate which prevents toddlers from pushing out screen doors, to provide a safety gate which clamps on to the sliding door enabling users to enter and exit easily, to provide a safety gate which assists in confining a child or like from exiting the home, to provide a safety gate which allows the user to leave their sliding door open and their screen door closed allowing circulation throughout the home, to provide a safety gate which allows the sliding door to stay open while having small infants or like in the area of the sliding door, provide a safety gate which is an additional detourant for families with swimming pools, and provide a safety gate which can be used easily and prevents indoor pets from ruining the screen door. Still further objects and advantages will become apparent from a consideration of the ensuing description and drawings.

### DRAWINGS—FIGURES

In the drawings, you will find figures that have different numbers but different reference numerals describing what is on the invention. It should be understood that the drawings are provided for the purpose of illustration only and are not intended to define the limits of the invention. The foregoing and other objects and advantages of the present invention will become apparent with reference to the following detailed description when taken in conjunction with the accompanying drawings in which:

FIG. 1 is the front elevational view of the sliding door safety gate's back and front panel

FIG. 2 is the front elevational view of the sliding door safety gate's stationary vertical gate support

FIG. 3 is a type of sliding door safety gate hinge, clamp, and sliding mechanism

FIG. 4 is the front elevational view of the complete sliding door safety gate

FIG. 5 is the top view of the sliding door safety gate and type of adjustable locking mechanism

### DRAWING—REFERENCE NUMERALS

10 Back Panel
20 Front Panel
30 Stationary Vertical Gate Support
40 Hinge
50 Sliding Door Clamps
60 Connecting Slidable Clamps
70 Locking Mechanism
80 Height adjustment pin
90 Shield or Screen

### DETAILED DESCRIPTION

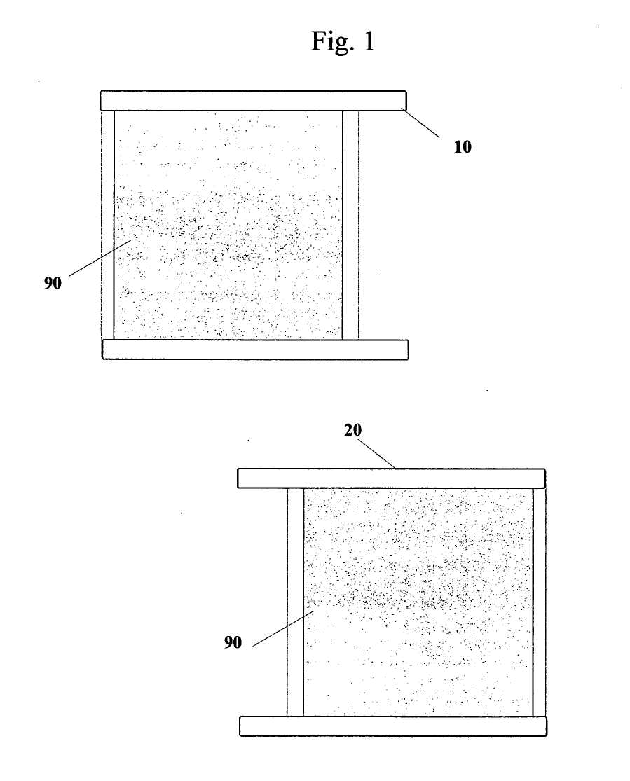

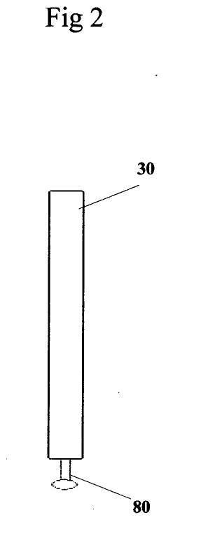

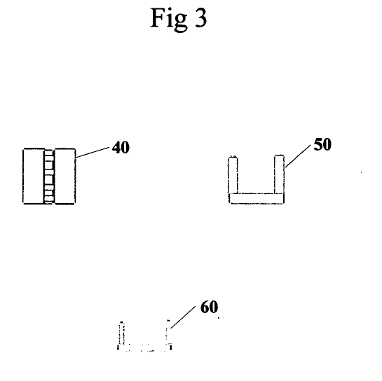

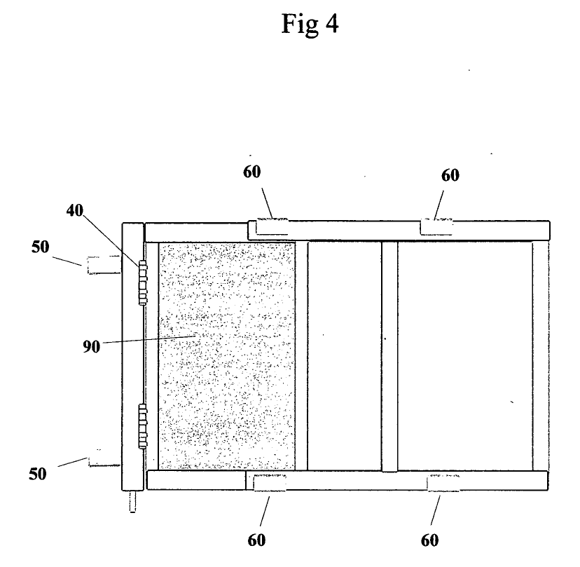

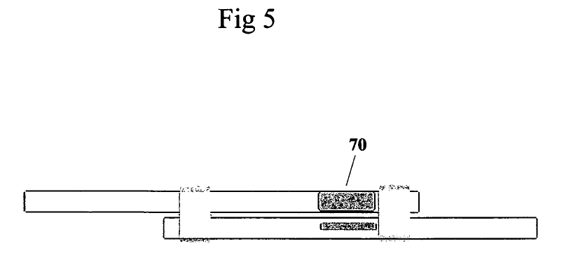

The sliding door safety gate shown in FIGS. 1-5 is comprised of two major gate sections, including a back panel section 1 and a front panel section 2, disposed in face-to-face relationship with one another and slidably connected together with connecting slidable clamps 60 so that the effective total width of the gate may be adjusted to accommodate the various widths of the sliding door to be obstructed by the gate. The connecting slidable clamps 60 could be comprised of a type of metal, aluminum, steel, plastic, wood, particle board, or any type of durable material.

The back panel section 10 is stationary and has a part of the locking latch mechanism 70 attached to the top portion of the gate. The back panel section 10 has the stationary vertical gate support 30 attached, along with a type of hinge 40 which allows the sliding door gate to swing open in any direction. In order for the sliding door gate to be stationary a type of clamp 50 is attached to the end of the stationary vertical gate support 30, this allows the gate to be attached to a sliding door without slipping. In addition, the vertical gate support 30 has a height adjustment pin 80 which allows the user to adjust the height of the gate off of the sliding door track.

The front panel 20 extends and is adjustable to the sliding doors width. The front panel 20 also includes the second adjustable part of the locking latch mechanism, which allows the gate to be adjusted to different openings. A type of stationery bumper could be added to the front panel 20, which is located at the side end of the adjustable panel 20 in order to create a snug fit and to protect the sliding door track from damage.

The back 10 or front panel 20 section may be comprised of wood, plastic, particle board, metal, or any type of durable material. The screen 90 may be comprised of wood, plastic, particle board, metal, nylon, cotton, glass, or any type of material which will fill the space of the interior panel. The shield or screen 90 could be filled in or it could be a screen which allows the free flow of air through the gate but are small enough so as to preclude even a small child from putting a hand or foot through the mesh.

From the foregoing it can be realized that this invention provides a new concept of safety gates, for commercial use. The advantages over the prior art are to protect screen doors, easy for adults to enter and exit, detourant for the child, pet, or like from exiting home, allows better circulation throughout the home, and because the clamp attaches to the sliding door the gate is unable to slip from side to side which is a new concept.

### Operation—Figs

The manner of using the sliding door safety gate is to attach the sliding door clamp 50 to the sliding door, which is attached to the stationary vertical gate support 30. The height adjustment pin 80, which is located at the bottom of the stationary vertical gate support 30, is easily adjustable by twisting to desirable height. The front panel 20 is adjustable and is locked in place through the adjustable locking mechanism 70. This allows the user to lock the safety gate in place when entering or exiting the sliding door. The stationary vertical gate support serves as a pivot point for a type of hinge 40 allowing the user to swing open or close the safety gate. This sliding door safety gate could also have a safety gate alarm so it alarm the parent when a child or pet is tampering or has opened the safety gate.

Once the user is done using the safety gate, the user simply pulls up the end of the gate and pulls the gate straight off to reuse another day.

### Advantages

From the descriptions above, a number of advantages of the sliding door safety gate become evident:
a) For the commercial use this product is easy to use and majority of homes and apartments use sliding doors
b) The safety gate could be reused
c) The safety gate detours small children, pets, or like from exiting the sliding door
d) The safety gate allows the user to enter and exit easily.
e) The safety gate protects the patio screen door from damages
f) The safety gate allows the user to enjoy the free flow of air
g) The safety gate is stable and will not slide from side to side
h) The safety gate adjusts to width of sliding door
i) The safety gate allows the user to enjoy the sliding door being open knowing that their small child, pet, or like will not walk outside

Accordingly, the reader will see that this sliding door safety gate can be used easily and conveniently to detour small children, pets, or like from exiting the sliding door. Furthermore, this sliding door safety gate has the additional advantages in that
it simplifies the use and is inexpensive to manufacture, and is light weight
it provides a stable entrance and exit of the sliding door
it provides assistance for detouring small children, pets, or like from exiting the sliding door
it provides a shield which prevents small children or pets from pushing on or out the screen doors
it provides a shield which prevents indoor pets from scratching the patio screen

Although the description above contains many specifications, these should not be construed as limiting the scope of the invention but as merely providing illustrations of some of the presently preferred embodiments of this invention. For example, this sliding door safety gate can have other shapes, such as oval, circular, triangular, etc.

Thus the scope of the invention should be determined by the appended claims and their legal equivalents, rather than by the examples given.

1. A sliding door safety gate for obstructing the sliding door opening, the gate comprising:
a panel of one or more;
a connecting clamp of one or more to engage said safety gate in operative communication;
a gate support means operatively attached to said panel to facilitate clamping said safety gate to a sliding door panel of a sliding door structure: and
means for locking said panel of said safety gate in a stationary position during use of said safety gate.

2. The safety gate in claim 1, wherein the panel includes a pair of gate sections slidably connected together and having an effective combined width that may be varied to obstruct openings of different widths.

3. The safety gate in claim 2, further comprising a type of locking mechanism constructed and arranged to secure at least one panel to maintain a desired width.

4. The safety gate in claim 1, further comprising of one or more clamps which are capable of clamping onto the sliding glass door.

5. The safety gate in claim 1, further comprising of one or more hinges allow one or more panels to swing open and close easily.

6. The safety gate in claim 1, further comprising of a said bumper on said panel which could be mounted on a gate section to adjust to the inside of the sliding door track.

7. A further method of using the sliding door safety gate in claim 1 comprising;
a bumper of one or more which is added to a panel to protect the sliding door track; and
a said gate inserted to fit within the opening of the sliding door track.

8. The safety gate in claim 1, further comprising a type of locking mechanism to secure said panel.

9. A sliding door safety gate for obstructing an opening associated with the sliding door comprising;
a panel unit constructed and arranged to be positioned within the opening;
a stationary vertical gate support operatively positioned adjacent to a vertical member of said panel;
at least one sliding door clamp operatively clamping to said vertical gate support for engaging or disengaging the sliding door; and
a height adjustable pin operatively mounted on a bottom side of said stationary vertical gate support for positioning said gate within a sliding door structure

10. The safety gate in claim 9, wherein said panel unit comprises at least two panel sections adjustably connected to expand or contract within variable width dimensions to obstruct openings of different widths.

11. The safety gate in claim 10, further comprising a width adjustment locking mechanism constructed and arranged to secure said panel sections together to maintain a desired width.

12. The safety gate in claim 9, further comprising at least one or more bumpers operatively mounted on at least one of said panel sections to secure said safety gate within a sliding door structure.
